(19) United States
(12) Patent Application Publication
(10) Pub. No.: US 2018/0079151 A1
(43) Pub. Date: Mar. 22, 2018

(54) REINFORCED SHAPE DESIGN OF TARGET LOCATION IN ADDITIVELY MANUFACTURED COMPONENT AND RELATED METHODS

(71) Applicant: General Electric Company, Schenectady, NY (US)

(72) Inventors: Michal Tomasz Prugarewicz, Ruetihof (CH); Kseniya Denisova, Moscow (RU); Stefan Emanuel Martin, Zurich (CH)

(21) Appl. No.: 15/493,317

(22) Filed: Apr. 21, 2017

(30) Foreign Application Priority Data
Sep. 20, 2016 (RU) 2016137468

(51) Int. Cl. B29C 67/00; B33Y 10/00; B33Y 50/02; B33Y 80/00

(52) U.S. Cl. CPC B29C 67/0088; B29C 67/0077; B33Y 80/00; B33Y 50/02; B33Y 10/00

(57) ABSTRACT

Various aspects include additively manufactured components and related processes of forming such components. In some cases, a method of forming an additively manufactured component includes: identifying a target location in a data model representing a component to be manufactured; adding a reinforced region proximate the target location in the data model; and additively manufacturing the component including the target location and the reinforced region, wherein the additively manufacturing includes: forming the additively manufactured component; and heat treating the additively manufactured component, including the reinforced region, after the forming.

### BACKGROUND

The subject matter disclosed herein relates to the manufacture of components. Specifically, the subject matter disclosed herein relates to maintaining structural integrity in additively manufactured components.

Additive manufacturing is an increasingly prevalent approach for fabricating components in various sectors, including the industrial sector. Additive manufacturing processes can reduce design cycle time and material waste, and may provide for greater flexibility in fabricating custom components. However, components formed from additive manufacturing processes can be subject to particular stresses and structural concerns. Conventional approaches for additively manufacturing components fail to account for these particular stresses and structural concerns.

### BRIEF DESCRIPTION

Various aspects of the disclosure include additively manufactured components and related processes of forming such components. In some cases, a method of forming an additively manufactured component includes: identifying a target location in a data model representing a component to be manufactured; adding a reinforced region proximate the target location in the data model; and additively manufacturing the component including the target location and the reinforced region, wherein the additively manufacturing includes: forming the additively manufactured component; and heat treating the additively manufactured component, including the reinforced region, after the forming.

A first aspect of the disclosure includes a component having: a body formed by additive manufacturing; a target location within the body, the target location including at least one of an aperture, an edge or a corner in the body; and a reinforced region at least partially surrounding the target location, the reinforced region having a greater thickness than a portion of the body farther from the target location as measured through the body.

A second aspect of the disclosure includes a method of forming an additively manufactured component includes: identifying a target location in a data model representing a component to be manufactured; adding a reinforced region proximate the target location in the data model; and additively manufacturing the component including the target location and the reinforced region, wherein the additively manufacturing includes: forming the additively manufactured component; and heat treating the additively manufactured component, including the reinforced region, after the forming.

A third aspect of the disclosure includes a non-transitory computer readable storage medium storing code representative of a component, the component physically generated upon execution of the code by a computerized additive manufacturing system, the code including: code representing the component, the component including: a body formed; a target location within the body, the target location including at least one of an aperture, an edge or a corner in the body; and a reinforced region at least partially surrounding the target location, the reinforced region having a greater thickness than a portion of the body farther from the target location as measured through the body.

### BRIEF DESCRIPTION OF THE DRAWINGS

These and other features of this invention will be more readily understood from the following detailed description of the various aspects of the invention taken in conjunction with the accompanying drawings that depict various embodiments of the disclosure, in which:

FIG. 1 shows a flow diagram illustrating processes according to various embodiments of the disclosure.

FIG. 2 shows a cross-sectional view of an additively manufactured component prior to processes performed according to various embodiments of the disclosure.

FIG. 3 shows a cross-sectional view of an additively manufactured component after undergoing processes performed according to various embodiments of the disclosure.

FIG. 4 shows a cross-sectional view of an additively manufactured component prior to processes performed according to various embodiments of the disclosure.

FIG. 5 shows a cross-sectional view of an additively manufactured component after undergoing processes performed according to various embodiments of the disclosure.

FIG. 6 shows a plan view of the component of FIG. 5.

FIG. 7 shows a plan view of an additively manufactured component prior to processes performed according to various embodiments of the disclosure.

FIG. 8 shows a perspective cross-section of the component of FIG. 7.

FIG. 9 shows a plan view of an additively manufactured component after undergoing processes performed according to various embodiments of the disclosure.

FIG. 10 shows a perspective cross-section of the component of FIG. 9.

FIG. 11 shows a three-dimensional perspective view of an additively manufactured component prior to processes performed according to various embodiments of the disclosure.

FIG. 12 shows a three-dimensional perspective view of an additively manufactured component after undergoing processes performed according to various embodiments of the disclosure.

FIG. 13 shows a cross-sectional view of the component of FIG. 12.

FIG. 14 shows a three-dimensional perspective view of an additively manufactured component prior to processes performed according to various embodiments of the disclosure.

FIG. 15 shows a three-dimensional perspective view of an additively manufactured component after undergoing processes performed according to various embodiments of the disclosure.

FIG. 16 shows a cross-sectional view of the component of FIG. 15.

FIG. 17 shows a plan view of the component of FIGS. 15 and 16.

FIG. 18 shows a block diagram of an additive manufacturing process including a non-transitory computer readable storage medium storing code representative of a template according to embodiments of the disclosure.

It is noted that the drawings of the invention are not necessarily to scale.

The drawings are intended to depict only typical aspects of the invention, and therefore should not be considered as limiting the scope of the invention. In the drawings, like numbering represents like elements between the drawings.

### DETAILED DESCRIPTION

The subject matter disclosed herein relates to the manufacture of components. Specifically, the subject matter disclosed herein relates to maintaining structural integrity in additively manufactured components.

According to various embodiments of the disclosure, in contrast to conventional approaches, a target location (also referred to as a critical location) in a component formed by additive manufacturing is reinforced in order to mitigate structural compromise during subsequent heat treatment. Consequently, the additively manufactured component includes a reinforced region, e.g., a material build-up proximate the target location.

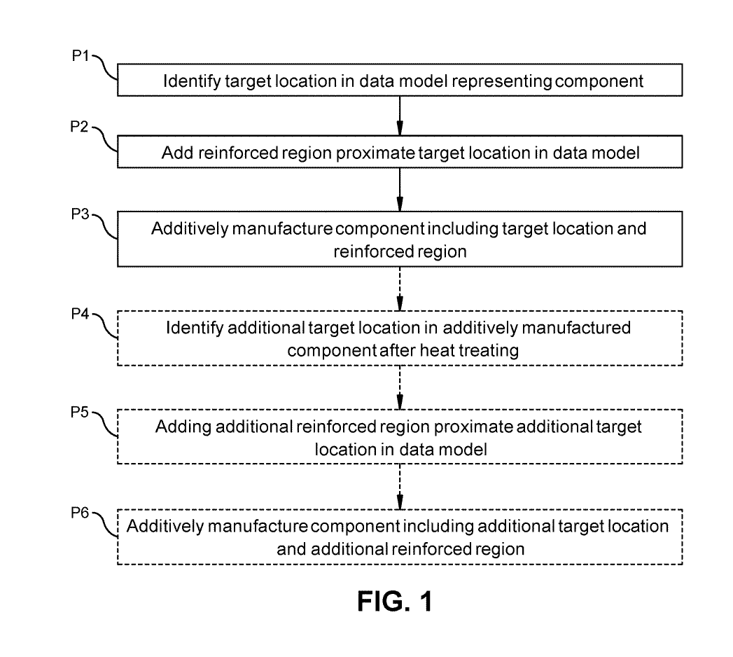

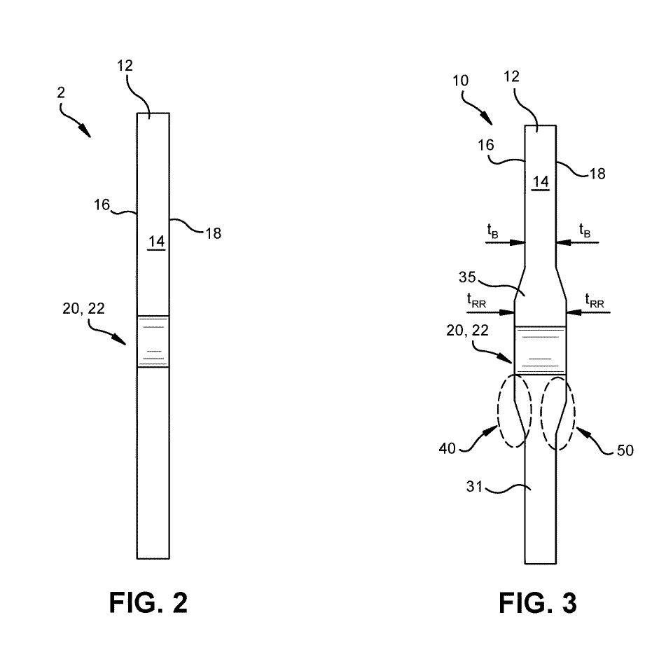

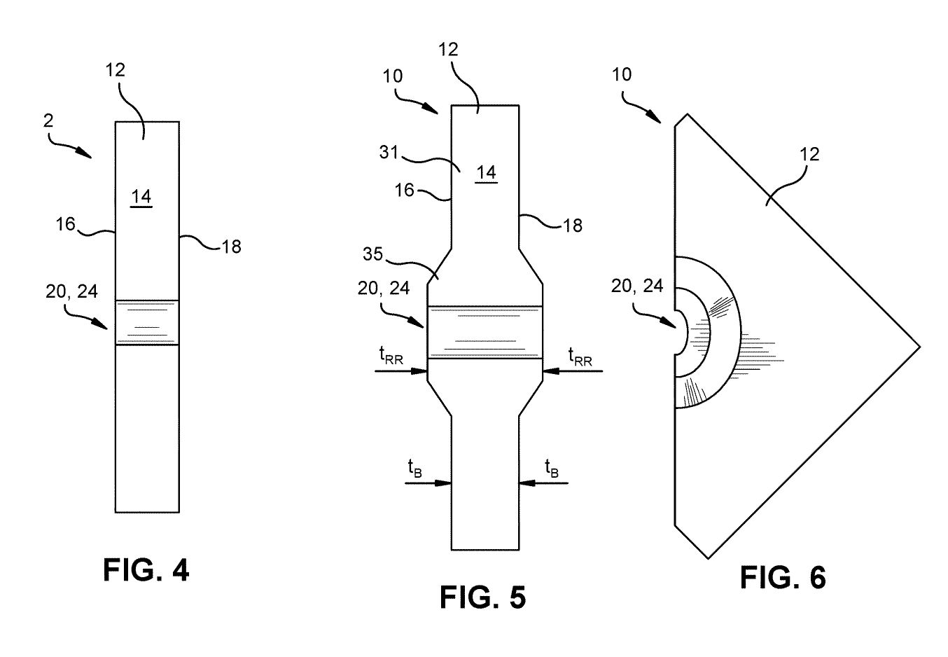

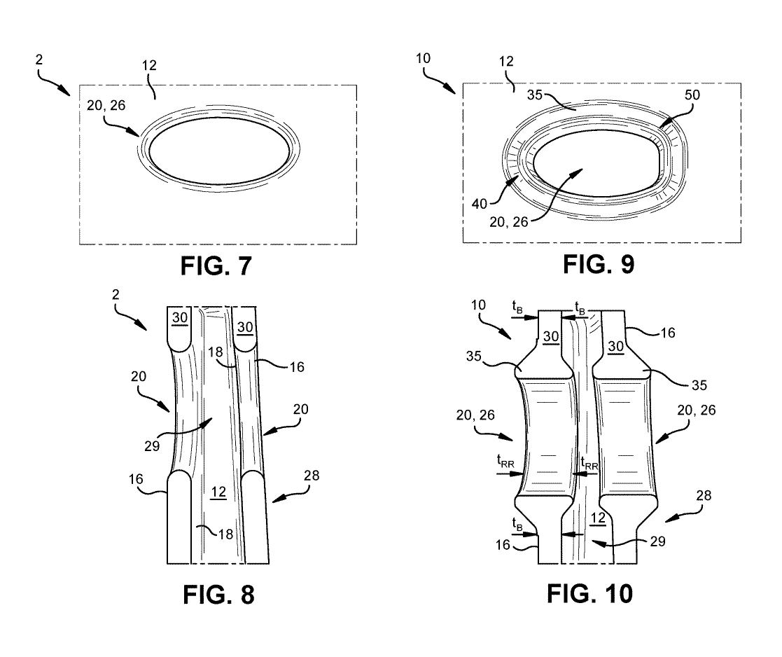

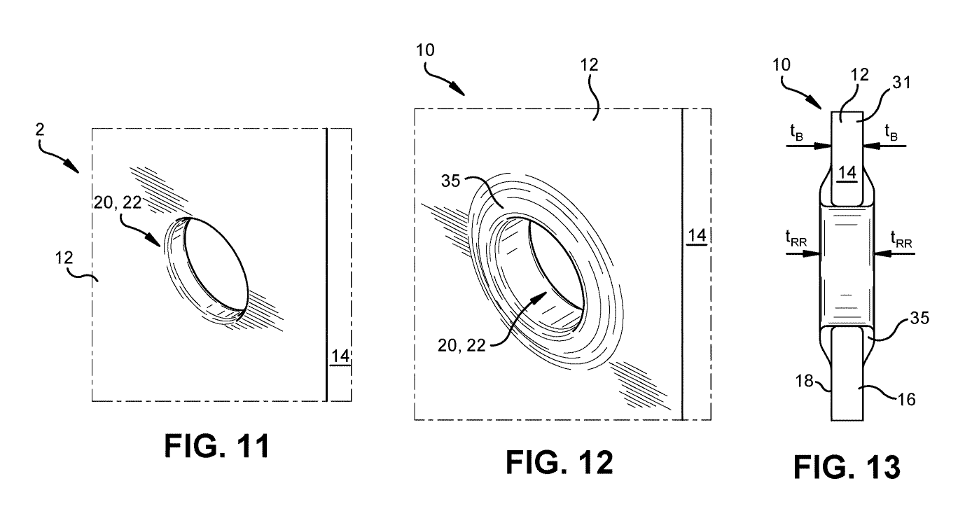

FIG. 1 shows a flow diagram illustrating various processes in additively manufacturing a component according to embodiments of the disclosure. FIGS. 2-11 illustrate cross-sectional and perspective views of additively manufactured components which illustrate various aspects of the disclosure. FIGS. 3, 5, 6, 9, 10, 12, 13 and 15-17 show additively manufactured components after processes performed according to various embodiments. Particular perspective views are referred to simultaneously with the flow diagram of FIG. 1.

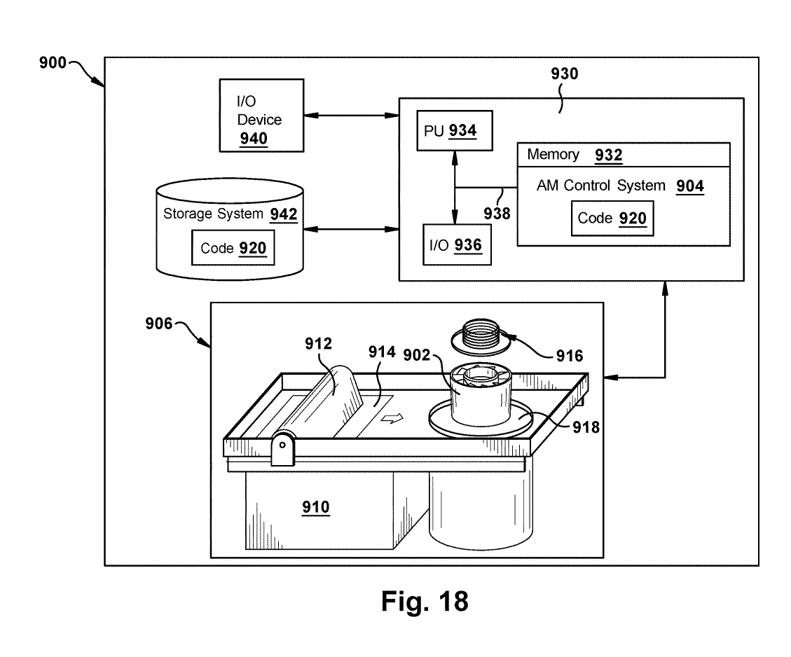

Turning to FIG. 2, a schematic cross-sectional depiction of a conventional additively manufactured component 2 is shown. This cross-sectional depiction may be formed from a data model, or may be a representation of a data model, for forming additively manufactured component 2. Data models are discussed further herein with respect to code 920 (FIG. 18) used to form additively manufactured components 2, 10 and other components. Additively manufactured (AM) components 10 shown in FIGS. 3, 5, 6, 9, 10, 12, 13 and 15-17 are examples of components formed according to various embodiments of the disclosure. AM components 10 can include a body 12 formed by additive manufacturing. The details of additive manufacturing are discussed further herein, with particular reference to FIG. 18. The body 12 of additively manufactured component 10 in some cases can include one or more walls 14, having a first surface (e.g., inner surface) 16 and an opposing second surface (e.g., outer surface) 18. It is understood that the terms first surface 16 and second surface 18 are only intended to act as relative terms, and may simply denote that one surface opposes the other. In various embodiments, both surfaces 16, 18 are external or internal surfaces, either exposed to ambient or other external conditions (e.g., steam, gas, etc.), or contacting an internal, or contained fluid (e.g., air).

In any case, AM component 10 can further include a target location 20 within body 12. Target location 20 can include any area subject to structural compromise in response to heat treatment during the additive manufacturing process. That is, target location 20 can include one or more areas where heat treatment can cause cracking, fracture, excessive strain, etc. in body 12. In various embodiments, target location 20 can include an aperture 22, which may extend between first surface 16 and second surface 18.

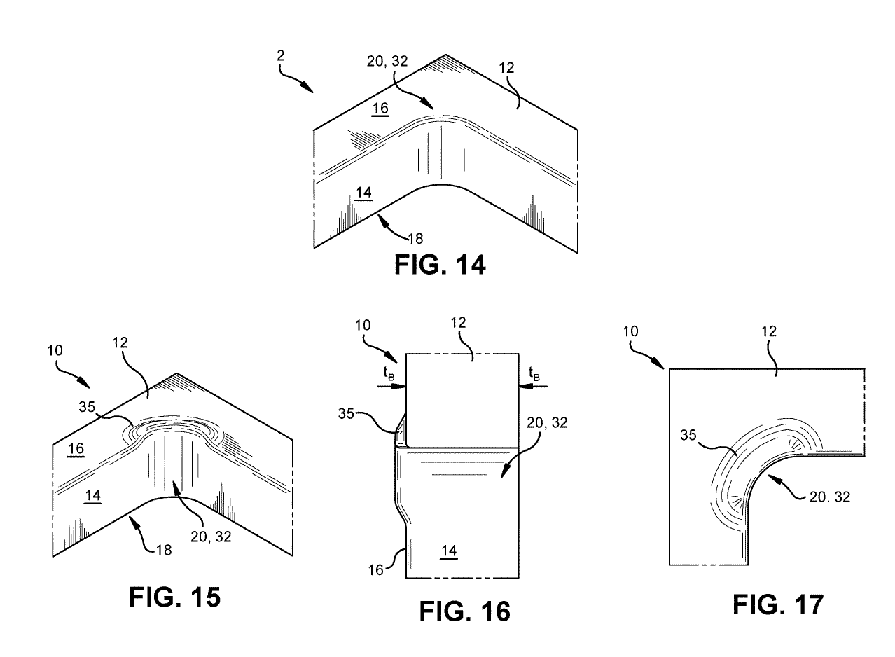

In some cases, e.g., as shown in the schematic depictions of FIGS. 2-17, target location(s) 20 can include various types of apertures 22. For example, FIGS. 5 and 6 illustrate a semi-circular (or half-moon shaped) aperture 24, as viewed from one of first surface 16 or second surface 18. FIGS. 9 and 10 illustrate a spherical (or oblong-shaped) aperture 26, as viewed from one of first surface 16 or second surface 18. In FIGS. 8 and 10, a double-walled body 28 is shown, including two distinct walls 30, each having a first surface 16 and a second surface 18. FIGS. 15-17 illustrate additional embodiments where target location 20 includes an edge or a corner 32 in body 12.

Returning to FIG. 1, with reference to FIGS. 2-17, a first process (process P1) in a method according to various embodiments can include identifying a target location 20 in the data model (code 920, FIG. 18) representing AM component 10. In various embodiments, this can include identifying at least one area of structural compromise, such as shape feature, e.g., aperture 24, 26 or an edge or corner 32, in the data model representing AM component 10. The area of structural compromise may be a location known to be subject to fracture, stress, cracking or other structural damage during heat treatment of AM component 10, or may be an area identified by modelling software as being subject to fracture, stress, cracking or other structural damage after heat treatment. In other embodiments, this process can include initially identifying the target location 20 in a manufactured sample of AM component 10, and subsequently noting that target location 20 in the data model (code 920) associated with (e.g., used to form) that AM component 10. In these cases, the process includes analyzing a manufactured sample of AM component 10 to detect at least one area of structural compromise, after the AM component 10 has been heat treated. AM component 10 may be analyzed by any conventional optical and/or mechanical stress identification tests.

Following identification of target location(s) 20, process P2 can include adding at least one reinforced region 35 proximate target location 20 in the data model (code 920). FIGS. 3, 5-7, 9, 10, 12, 13 and 15-17 each illustrate distinct examples of reinforced regions 35 proximate target locations 20. Referring, for example, to FIGS. 5-7, 9, 10, 12, 13 and 15-17, reinforced region 35 can at least partially surround target location 20. In various embodiments, reinforced region 35 includes a build-up, or thickening, of material used to form AM component 10 proximate target location 20. According to processes described herein, reinforced region 35 is added to the data model (in code 920, FIG. 18) to an area proximate target location 20 to thicken that area, e.g., by making body 12 thicker such as by increasing a distance between first surface 16 and second surface 18 proximate target location 20. As shown for example in in FIG. 3, in various embodiments, reinforced region 35 has a greater thickness (t_{RR}) than a portion 31 of body 12 (with thickness (t_{B})) farther from target location 20 as measured through body 12, e.g., as measured in a direction perpendicular to an outer surface (e.g., first surface 16) of body 12, or as measured between first surface 16 and second surface 18. In some cases, t_{RR} is equal to between approximately a maximum tolerance of t_{B} and approximately 2 times t_{B}

After adding reinforced region(s) 35 to the data model (code 920 for AM component 10, process P3 can include additively manufacturing the component 10 including target location 20 and reinforced region(s) 35. In various embodiments, this process includes forming the AM component 10, and then heat treating that AM component 10, including the reinforced region 35. As noted herein, heat treating can include curing or otherwise exposing manufactured AM component 10 to heat-based setting.

In some cases, additional processes can be performed after heat treatment, and can include:

Process P4: identifying an additional target location 20 in AM component 10 after the heat treating. In this case, AM component 10 may be analyzed, e.g., by any conventional optical and/or mechanical stress identification tests, as noted herein.

Process P5 and Process P6 can be substantially similar to processes P2 and P3, noted above, where Process P5 includes adding an additional reinforced region 35 proximate additional target location 20 in the data model (code 920); and Process P6 includes additively manufacturing AM component 10 (e.g., an additional sample) including additional target location 20 and additional reinforced region 35. It is understood that additively manufacturing the AM component 10 in process P6 can include manufacturing an additional sample of AM component 10, that is, a new iteration of AM component 10 with additional reinforced region(S) 35.

Returning to FIGS. 3, 9 and 10, according to various embodiments, it is understood that reinforced region 35 can be formed asymmetrically with respect to target location 20, such that reinforced region 35 may include a first region 40 having a first thickness, and a second region 50 having a second thickness (distinct from first thickness), surrounding target location 20. In some cases, reinforced region 35 is asymmetrical across target region 20, as shown in FIGS. 3 and 15-17. In other cases, reinforced region 35 is asymmetrical surrounding target region 20, such that a higher concentration of reinforcement material is located at first region 40 adjacent target region 20 as compared to second region 50, along a common surface (e.g., first surface 16 or second surface 18) of body 12. This scenario is illustrated in FIG. 9.

In various embodiments, as shown in FIGS. 9 and 10, in the case of double-walled body 28 (with space 29 between walls 30), reinforced region 35 includes two distinct reinforced regions 35, each in a wall 30 of double-walled body 28. In various embodiments, space 29 is narrowed, as measured between facing surfaces (e.g., second surfaces 18) of walls 28, at the reinforced regions 35.

In any case, AM components shown and described herein allow for reinforcement of target regions, e.g., those areas subject to structural compromise. The AM components formed according to various embodiments of the disclosure have the technical effect of reducing material failure in various systems employing such components.

As used herein, additive manufacturing (AM) may include any process of producing an object through the successive layering of material rather than the removal of material, which is the case with conventional processes. Additive manufacturing can create complex geometries without the use of any sort of tools, molds or fixtures, and with little or no waste material. Instead of machining components from solid billets of plastic, much of which is cut away and discarded, the only material used in additive manufacturing is what is required to shape the part. Additive manufacturing processes may include but are not limited to: 3D printing, rapid prototyping (RP), direct digital manufacturing (DDM), selective laser melting (SLM) and direct metal laser melting (DMLM).

To illustrate an example of an additive manufacturing process, FIG. 18 shows a schematic/block view of an illustrative computerized additive manufacturing system 900 for generating an object 902. In this example, system 900 is arranged for DMLM. It is understood that the general teachings of the disclosure are equally applicable to other forms of additive manufacturing. Object 902 is illustrated as a double walled turbine element; however, it is understood that the additive manufacturing process can be readily adapted to manufacture AM component 10. AM system 900 generally includes a computerized additive manufacturing (AM) control system 904 and an AM printer 906. AM system 900, as will be described, executes code 920 (e.g., a model) that includes a set of computer-executable instructions defining AM component 10 to physically generate the object using AM printer 906. Each AM process may use different raw materials in the form of, for example, fine-grain powder, liquid (e.g., polymers), sheet, etc., a stock of which may be held in a chamber 910 of AM printer 906. In the instant case, AM component 10 may be made of plastic/polymers or similar materials. As illustrated, an applicator 912 may create a thin layer of raw material 914 spread out as the blank canvas from which each successive slice of the final object will be created. In other cases, applicator 912 may directly apply or print the next layer onto a previous layer as defined by code 920, e.g., where the material is a polymer. In the example shown, a laser or electron beam 916 fuses particles for each slice, as defined by code 920, but this may not be necessary where a quick setting liquid plastic/polymer is employed. Various parts of AM printer 906 may move to accommodate the addition of each new layer, e.g., a build platform 918 may lower and/or chamber 910 and/or applicator 912 may rise after each layer.

AM control system 904 is shown implemented on computer 930 as computer program code. To this extent, computer 930 is shown including a memory 932, a processor 934, an input/output (I/O) interface 936, and a bus 938. Further, computer 930 is shown in communication with an external I/O device/resource 940 and a storage system 942. In general, processor 934 executes computer program code, such as AM control system 904, that is stored in memory 932 and/or storage system 942 under instructions from code 920 representative of AM component 10, described herein. While executing computer program code, processor 934 can read and/or write data to/from memory 932, storage system 942, I/O device 940 and/or AM printer 906. Bus 938 provides a communication link between each of the components in computer 930, and I/O device 940 can comprise any device that enables a user to interact with computer 940 (e.g., keyboard, pointing device, display, etc.). Computer 930 is only representative of various possible combinations of hardware and software. For example, processor 934 may comprise a single processing unit, or be distributed across one or more processing units in one or more locations, e.g., on a client and server. Similarly, memory 932 and/or storage system 942 may reside at one or more physical locations. Memory 932 and/or storage system 942 can comprise any combination of various types of non-transitory computer readable storage medium including magnetic media, optical media, random access memory (RAM), read only memory (ROM), etc. Computer 930 can comprise any type of computing device such as a network server, a desktop computer, a laptop, a handheld device, a mobile phone, a pager, a personal data assistant, etc.

Additive manufacturing processes begin with a non-transitory computer readable storage medium (e.g., memory 932, storage system 942, etc.) storing code 920 representative of AM component 10. As noted, code 920 includes a set of computer-executable instructions defining AM component 10, upon execution of the code by system 900. For example, code 920 may include a precisely defined 3D model of AM component 10 and can be generated from any of a large variety of well-known computer aided design (CAD) software systems such as AutoCAD®, TurboCAD®, DesignCAD 3D Max, etc. In this regard, code 920 can take any now known or later developed file format. For example, code 920 may be in the Standard Tessellation Language (STL) which was created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Code 920 may be translated between different formats, converted into a set of data signals and transmitted, received as a set of data signals and converted to code, stored, etc., as necessary. Code 920 may be an input to system 900 and may come from a part designer, an intellectual property (IP) provider, a design company, the operator or owner of system 900, or from other sources. In any event, AM control system 904 executes code 920, dividing AM component 10 into a series of thin slices that it assembles using AM printer 906 in successive layers of liquid, powder, sheet or other material. In the DMLM example, each layer is melted to the exact geometry defined by code 920 and fused to the preceding layer. Subsequently, the AM component 10 may be exposed to any variety of finishing processes, e.g., minor machining, sealing, polishing, assembly to other part of the igniter tip, etc.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A component comprising:
a body formed by additive manufacturing;
a target location within the body, the target location including at least one of an aperture, an edge or a corner in the body; and
a reinforced region at least partially surrounding the target location, the reinforced region having a greater thickness than a portion of the body farther from the target location as measured through the body.

2. The component of claim 1, wherein the reinforced region is asymmetrical with respect to the target location, either across the target region or surrounding the target region.

3. The component of claim 1, wherein the body includes a doubled-walled body separated by a space, and wherein the reinforced region includes two distinct reinforced regions, each in a wall of the double-walled body.

4. The component of claim 1, wherein the aperture includes a half-moon shaped aperture as viewed from an outer surface of the body.

5. The component of claim 1, wherein the body includes a single-walled body, and wherein the reinforced region is measured in a direction perpendicular to an outer surface of the body.

6. The component of claim 5, wherein the reinforced region has a thickness between approximately a maximum tolerance of a thickness of the single-walled body and approximately two times a thickness of the single-walled body.

7. The component of claim 1, wherein the target location includes an area subject to structural compromise in response to heat treatment.

8. A method comprising:
identifying a target location in a data model representing a component to be manufactured;
adding a reinforced region proximate the target location in the data model; and
additively manufacturing the component including the target location and the reinforced region, wherein the additively manufacturing includes:
forming the additively manufactured component; and
heat treating the additively manufactured component, including the reinforced region, after the forming.

9. The method of claim 8, wherein the identifying of the target location includes analyzing the data model to detect at least one area of structural compromise.

10. The method of claim 8, wherein the identifying of the target location includes analyzing a manufactured sample of the component to detect at least one area of structural compromise, wherein the analyzing is performed after heat treating the additively manufactured component.

11. The method of claim 8, further comprising identifying an additional target location in the additively manufactured component after the heat treating.

12. The method of claim 11, further comprising:
adding an additional reinforced region proximate the additional target location in the data model; and
additively manufacturing the component including the additional target location and the additional reinforced region.

13. The method of claim 7, wherein the target location includes an area subject to structural compromise in response to the heat treatment.

14. A non-transitory computer readable storage medium storing code representative of a component, the component physically generated upon execution of the code by a computerized additive manufacturing system, the code comprising:
code representing the component, the component including:
a body formed;
a target location within the body, the target location including at least one of an aperture, an edge or a corner in the body; and
a reinforced region at least partially surrounding the target location, the reinforced region having a greater thickness than a portion of the body farther from the target location as measured through the body.

15. The storage medium of claim 14, wherein the reinforced region is asymmetrical with respect to the target location, either across the target region or surrounding the target region.

16. The storage medium of claim 14, wherein the body includes a doubled-walled body separated by a space, and wherein the reinforced region includes two distinct reinforced regions, each in a wall of the double-walled body.

17. The storage medium of claim 14, wherein the aperture includes a half-moon shaped aperture as viewed from an outer surface of the body.

18. The storage medium of claim 14, wherein the body includes a single-walled body, and wherein the reinforced region is measured in a direction perpendicular to an outer surface of the body.

19. The storage medium of claim 18, wherein the reinforced region has a thickness between approximately a maximum tolerance of a thickness of the single-walled body and approximately 2 times a thickness of the single-walled body.

20. The storage medium of claim 14, wherein the target location includes an area subject to structural compromise in response to heat treatment.
